(19) United States
(12) Patent Application Publication
(10) Pub. No.: US 2014/0202676 A1
(43) Pub. Date: Jul. 24, 2014

(54) FIXING ASSEMBLY FOR HEAT SINK

(71) Applicants: Hon Hai Precision Industry Co., Ltd., New Taipei (TW); Hong Fu Jin Precision Industry (ShenZhen) Co., Ltd, Shenzhen (CN)

(72) Inventors: ZHEN-YU WANG, Shenzhen (CN); CHANG-SHEN CHANG, New Taipei (TW)

(73) Assignees: Hon Hai Precision Industry Co., Ltd., New Taipei (TW); Hong Fu Jin Precision Industry (ShenZhen) Co., Ltd, New Taipei (TW)

(21) Appl. No.: 13/966,389

(22) Filed: Aug. 14, 2013

(30) Foreign Application Priority Data
Jan. 19, 2013 (CN) 2013100190410

(51) Int. Cl. F16B 41/00

(52) U.S. Cl. CPC F16B 41/002
USPC 165/185; 411/103

(57) ABSTRACT

A fixing assembly includes a main body, a fixing member, and a limiting member secured to the main body. The limiting member angles with the main body to form a limited but resiliently deformable space for mounting of the fixing member, but then restores to hold the fixing member captive and avoid the displacement or loss of the fixing member at any time. A heat sink using the fixing assembly is also provided.

### BACKGROUND

1. Technical Field

The present disclosure relates to fixing assemblies, and more particularly, to a fixing assembly for fixing heat sinks.

2. Description of Related Art

Referring to FIG. 6, a heat sink (not shown) is secured to a housing (not shown) by an assembly 400. The assembly 400 includes a fixing plate 410 fixed to the heat sink, a bolt 420 for securing the fixing plate 410 to the housing, and an elastic throttling member 430. The fixing plate 410 defines a though hole 412 having a diameter R1 for mounting the bolt 420. The bolt 420 includes a head portion 422, a connecting portion 424 extending from the head portion 422, and a threaded shank 426 extending from an end of the connecting portion 424 away from the head portion 422. The diameter of the head portion 422 is greater than the diameter R1 of the through hole 420. The diameter of the connecting portion 424 is less than the diameter R1 of the through hole 420. The diameter of the threaded shank 426 is greater than the diameter of the connecting portion 424, but is less than the diameter R1 of the through hole 420 to allow insertion of the bolt 420. The elastic throttling member 430 is substantially O-shaped or C shaped and defines a round hole 432. The outer diameter of the elastic throttling member 430 is greater than the diameter R1 of the through hole 420, and the inner diameter R2 of the throttling member 430 is greater than the diameter of the connecting portion 424, but is less than the diameter of the threaded shank 426. However, to mount the bolt 420 to the fixing plate 410, the bolt 420 is first inserted into the through hole 422, then, the throttling member 430 is manually forced over the threaded shank 426 to keep the bolt 420 in position on the fixing plate 410, which requires intricate and forceful assembling of the bolt 420. Repeated mounting and demounting of the bolt 410 also cause deterioration in the function of the elastic throttling member 430.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of a heat sink including a fixing assembly in accordance with an embodiment.

FIG. 2 is a disassembled view of the fixing assembly in FIG. 1; the fixing assembly includes a fixing member.

FIG. 3 is an assembled view of the fixing assembly in FIG. 2.

FIG. 4 is a cross-sectional view taken along line IV-IV in FIG. 4.

FIG. 5 is a view showing the fixing member in FIG. 3 being mounted.

FIG. 6 illustrates a perspective view of a fixing assembly of related art.

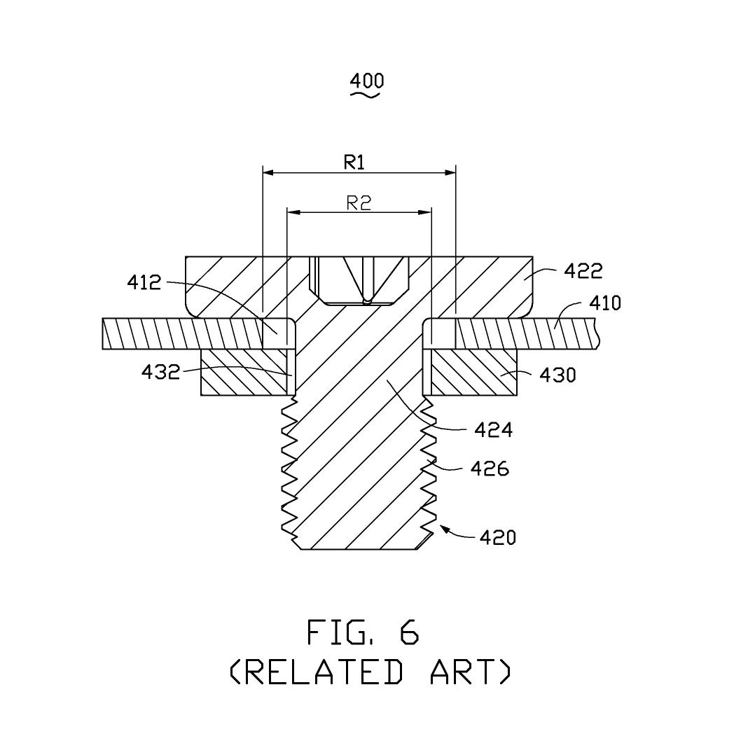

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

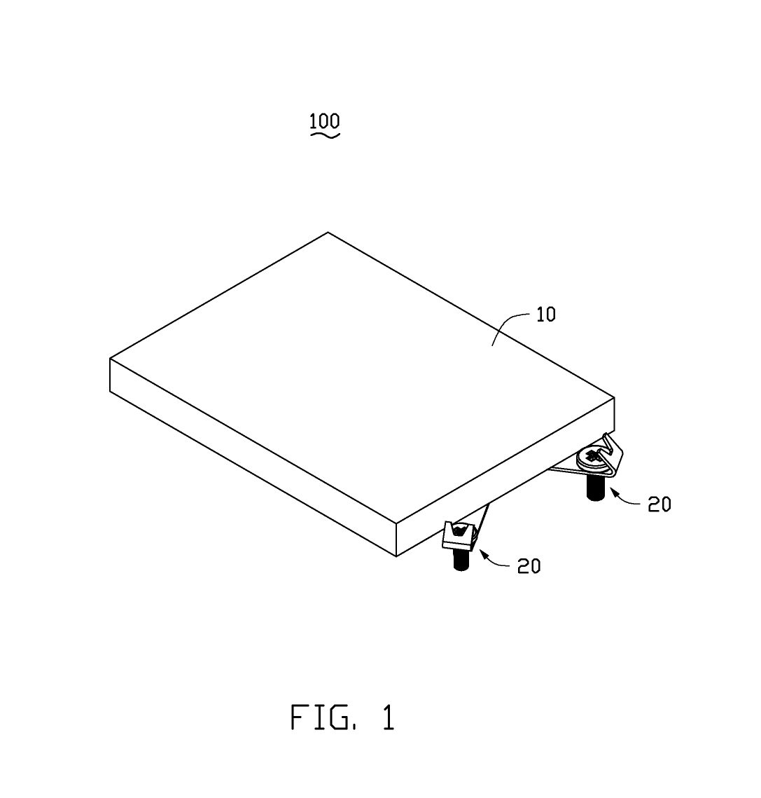

Referring to FIG. 1, a heat sink 100 in accordance with an embodiment is shown. The heat sink 100 includes a heat-dissipating module 10, and a plurality of fixing assemblies 20 for fixing the head-dissipating module 10 to a base (not shown).

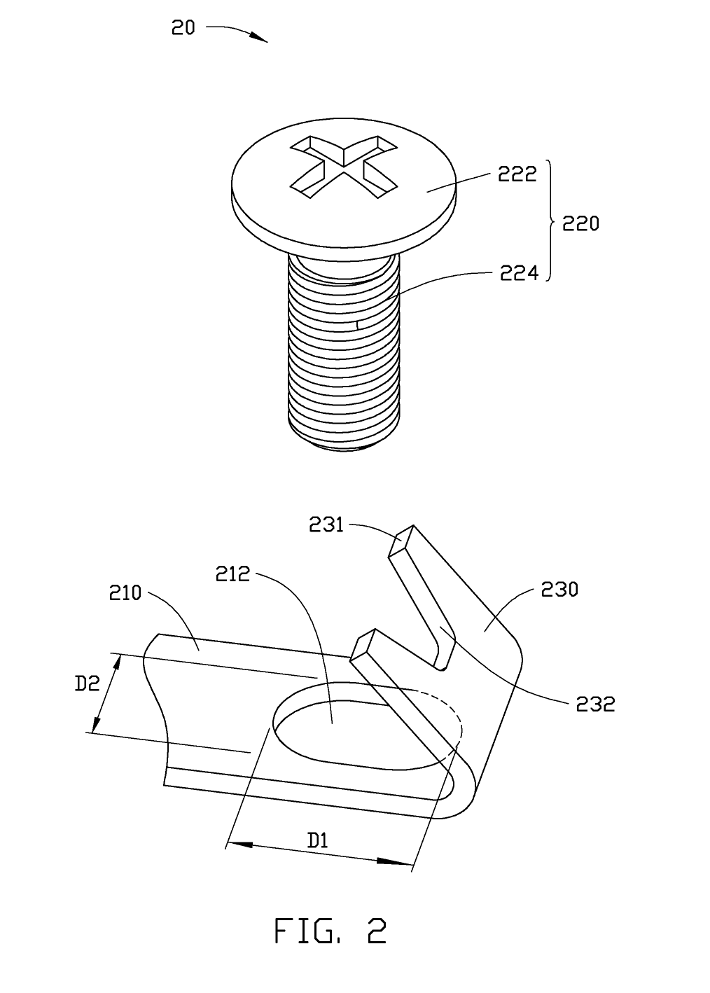

Referring to FIG. 2, each fixing assembly 20 includes a main body 210, a fixing member 220, and a limiting member 230. The main body 210 is fixed to the heat-dissipating module 10. An end of the main body 220 away from the heat-dissipating module 10 defines a through slot 212. The through slot 212 has a length D1 in a longitudinal direction of the main body 210, and a width D2 less than the length D1. The main body 210 in the embodiment is made of metal having high thermal conduction, to provide high heat dissipation capability.

The fixing member 220 is mounted to main body 210 by being inserted through the through slot 212, and is adapted to fix the main body 210 to the base. The fixing member 220 in the embodiment is a screw or bolt. The fixing member 220 includes a head portion 222 and a threaded shank 224 fixed to the head portion 222. The diameter of the head portion 222 is greater than the length D1 of the through slot 212. The diameter of the threaded shank 224 is slightly less than the width D2 of the through slot 212, whereby the threaded shank 224 is fitted in the through slot 212 in a direction perpendicular to the longitudinal direction of the main body 210. The diameter of the threaded shank 224 is greater than the length D1 of the though hole 212, to allow slanted or canted entry of the fixing member 210.

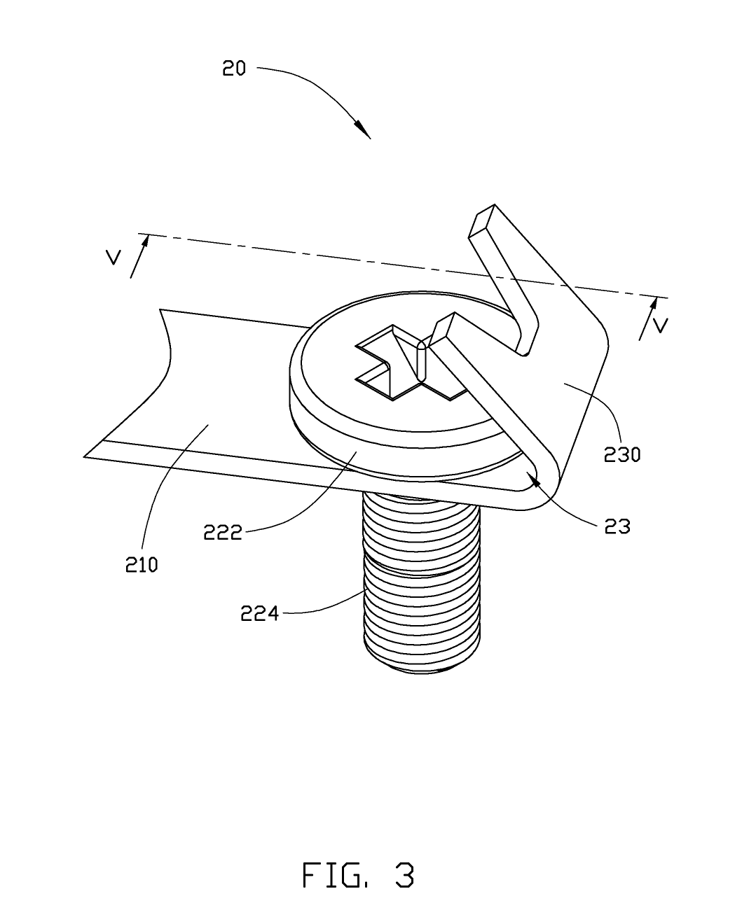

Also referring to FIG. 3, the limiting member 230 is made of non-rigid and resilient material. The limiting member 230 is secured to the main body 210 and is arranged at one side of the through slot 212. The limiting member 230 keeps the fixing member 220 always captive after the fixing member 220 is mounted to the main body 210. The limiting member 230 in the embodiment is integral and bent from an end of the main body 210 away from the head-dissipating module 10, and is further slanted toward the head-dissipating module 10. The limiting member 230 makes an angle with the main body 210, to form a limiting space 234. After the fixing member 220 is mounted to the main body 210, the head portion 222 is held captive, prevented from being displaced or falling off. The projection of a distal end 231 to the main body 210 is vertically above the longitudinal direction of the through slot 212. The distal end 231 is recessed to form a substantially V-shaped recess 232 for facilitating the mounting of the fixing member 220 to the through slot 212. The width of the recess 232 gradually reduces inwards from the distal end 231.

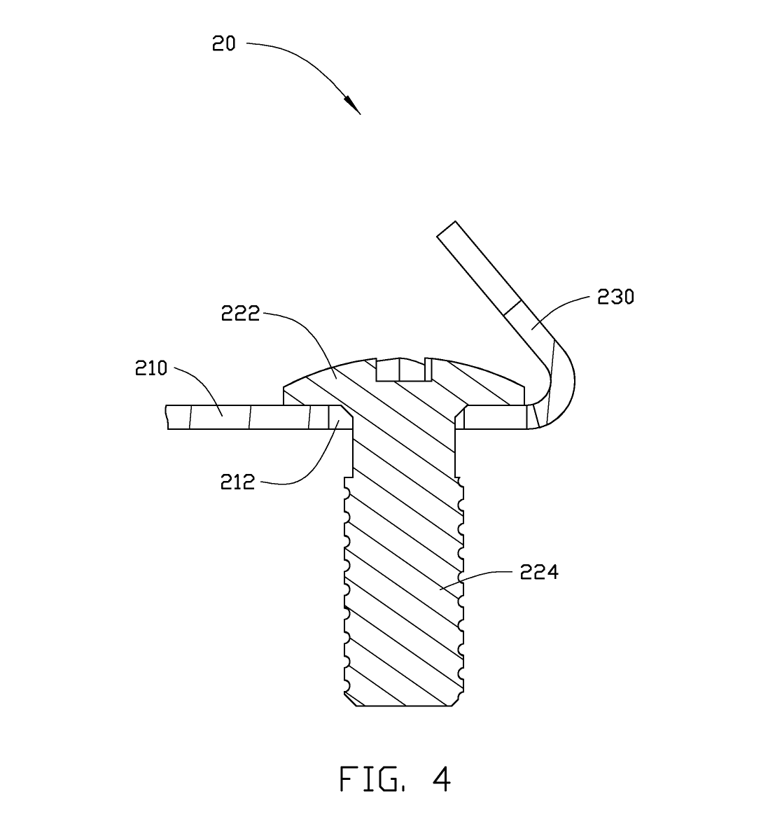

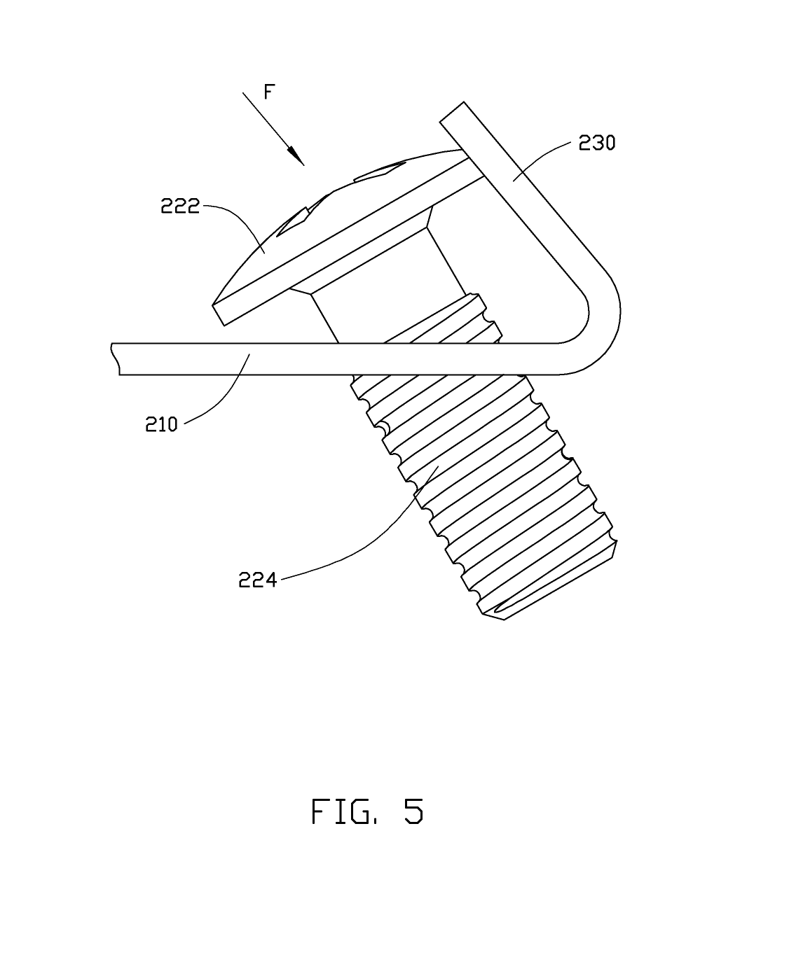

Referring to FIG. 5, in assembly, the shank 224 of the fixing member 220 is slantingly inserted into the through slot 212, and a portion of the head portion 222 is received in the recess 232. At this time, the limiting member 230 is in an original state to prevent the fixing member 220 from moving toward the main body 210. An external force F is exerted to the head portion 222, to force the head portion 222 to slide along the recess 232 toward the main body 210. At this time, the head portion 222 abuts and presses against the limiting member 230, and the limiting member 230 gives way to make room for allowing the fixing member 220 to be mounted to the main body 210. Referring also to FIGS. 3 and 4, after the fixing member 220 is mounted to the main body 210, the limiting member 230 restores to its original shape to limit the head portion 222 in the limiting space 234. As a result, the limiting member 220 is prevented from being displaced or falling off.

In the embodiment, when the head portion 222 is mounted to the main body 210 and the stopping portions 232 restores to its original shape, the shank 224 abuts an edge of the through slot 212 away from the limiting member 230, opposite surfaces of an end of the head portion 222 abut the main body 210 and the limiting member 230 simultaneously, whereby movement of the limiting member 220 is tightly limited.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A fixing assembly, comprising:
a main body defining a through slot;
a fixing member mounted to the main body by being inserted through the through slot; and
a limiting member secured to the main body and arranged at a side of the through slot;
wherein the limiting member makes an angle with the main body and keeps the fixing member captive, to prevent the fixing member from falling off after the fixing member is mounted to the main body.

2. The fixing assembly of claim 1, wherein the fixing member comprises a head portion and a threaded shank fixed to the head portion, the diameter of the head portion is greater than the length of the through slot, and the diameter of the threaded shank is slightly greater than the width of the through slot which is less than the length thereof.

3. The fixing assembly of claim 1, wherein a distal end of the limiting member away from the main body defines a recess for facilitating the mounting of the fixing member to the through slot.

4. The fixing assembly of claim 3, wherein the width of the recess is gradually reduced inwards from the distal end.

5. The fixing assembly of claim 3, wherein a projection of a distal end of the limiting member to the main body is vertically above the longitudinal direction of the through slot.

6. The fixing assembly of claim 1, wherein the limiting member integrally extends from the main body.

7. The fixing assembly of claim 1, wherein the limiting members are made of non-rigid and resilient material.

8. A heat sink, comprising:
a heat-dissipating module; and
a fixing assembly for fixing the heat-dissipating module, the fixing assembly comprising:
a main body defining an through slot;
a fixing member mounted to the main body by being inserted through the through slot; and
a limiting member secured to the main body and arranged at a side of the through slot;
wherein the limiting member make an angle with the main body to hold the fixing member captive, to prevent the fixing member from falling off after the fixing member is mounted to the main body.

9. The heat sink of claim 8, wherein the fixing member comprises a head portion and a threaded shank fixed to the head portion, the diameter of the head portion is greater than the length of the through slot, and the diameter of the threaded shank is slightly greater than the width of the through slot which less than the length thereof.

10. The heat sink of claim 8, wherein a distal end of the limiting member away from the main body defines a recess for facilitating the mounting of the fixing member to the through slot.

11. The heat sink of claim 10, wherein the width of the recess is gradually reduced inwards from the distal end.

12. The heat sink of claim 10, wherein projection of a distal end of the limiting member to the main body is vertically above the longitudinal direction of the through slot.

13. The heat sink of claim 8, wherein the limiting member integrally extends from the main body.

14. The heat sink of claim 8, wherein the limiting members are made of non-rigid and resilient material.
